(19) United States
(12) Patent Application Publication
(10) Pub. No.: US 2007/0203617 A1
(43) Pub. Date: Aug. 30, 2007

(54) Driver assistance system and method for its control

(76) Inventor: Karsten Haug, Stuttgart (DE)

Correspondence Address: KENYON & KENYON LLP, ONE BROADWAY, NEW YORK, NY, 10004, US

(21) Appl. No.: 11/701,025

(22) Filed: Jan. 31, 2007

(30) Foreign Application Priority Data
Feb. 2, 2006 (DE) 10 2006 004 772.9

(51) Int. Cl. G06F 7/00

(52) U.S. Cl. 701/1; 701/36; 701/41

(57) ABSTRACT

A driver assistance system 1 includes at least driver assistance functions such as LDW (lane departure warning) and LKS (lane keeping support). The activation and deactivation of the driver assistance functions (LDW, LKS) are a function of a confidence level V.

### FIELD OF THE INVENTION

The present invention relates to a driver assistance system. Furthermore, the present invention relates to a method for controlling a driver assistance system.

### BACKGROUND INFORMATION

Driver assistance systems of the generic type are to support the driver while driving the vehicle and are to make it easier for the driver to drive the vehicle, in particular in the event of poor visibility conditions, heavy traffic volume in the traffic area, or long drives. A driver assistance system of this type may advantageously help the driver stay in a lane. Thus, at least one warning may be given upon departing from the lane. This function of the driver assistance system is typically referred to as LDW (lane departure warning). Greater support is offered to the driver by a further function of the driver assistance system, which is referred to as LKS (lane keeping support). This function makes it easier for the vehicle to stay in the lane automatically by an active intervention in the steering system and possibly further systems of the vehicle, such as the brake system in particular (for example, asymmetrical braking intervention). LKS is considered a trend-setting driver assistance function, since a significant customer benefit is ascribed thereto. However, permitting this function for street traffic is problematic since an active intervention in the steering system of the vehicle is typically required at velocities of more than approximately 5 km/h. The fact that a high steering torque is required for good functional implementation in order to be able to laterally steer the vehicle automatically even in tight curves and/or at high velocity is considered particularly critical. An increased risk is seen therein, since the driver, in particular in the event of inattentiveness, may be surprised by the high steering torque and may thus be caused to perform a faulty operation. Therefore, only a comparatively low steering torque is used with an active LKS function in the driver assistance systems already permitted in a few countries. However, this has the disadvantage that this driver assistance function is not very effective and is not optimally usable in the event of tight curves and/or at high velocity in particular. In order to be able to detect the course of the lane, on the basis of roadway markings, for example, a driver assistance system typically also includes sensors for detecting the vehicle surroundings. The sensors may be video sensors and/or scanning lidar sensors, for example, which may be used independently of one another or operated in combination.

### SUMMARY OF THE INVENTION

The driver assistance system according to the present invention and the method for controlling a driver assistance system of this type allow a significant improvement on a driver assistance system having an LKS function. The exemplary embodiment and/or exemplary method of the present invention is based on the assumption that a safe and practice-compatible application of this functionality may be provided by a flexible adaptation of the steering torque to diverse parameters. The activation or deactivation of a driver assistance function is particularly advantageously made a function of a confidence level. With a high confidence level, a driver assistance function such as LDW or LKS is completely active and may be used optimally for increasing the comfort of the driver. In the case of a decreasing confidence level, functional variables of a driver assistance function, such as the steering torque, are returned to a lower value in driver assistance function LKS or the driver assistance function is even deactivated completely. To ensure a stable and reproducible use of driver assistance functions, threshold values are advantageously predefined. If the confidence level falls below a threshold value, for example, the steering torque provided for driver assistance function LKS is reduced or the driver assistance function is turned off. The confidence level is particularly advantageously determined from sensor signals, which allow a reliable statement about the particular environmental conditions to which the vehicle and the driver are subjected in the traffic surroundings. Further advantages result from the subclaims in connection with the associated description and drawing.

### BRIEF DESCRIPTION OF THE DRAWINGS

FIG. 1 shows a first graph having an illustration of the availability of driver assistance functions as a function of the confidence level.

FIG. 2 shows a second graph having an illustration of the maximum steering torque of driver assistance function LKS as a function of the confidence level.

FIG. 3 shows a block diagram of a driver assistance system.

### DETAILED DESCRIPTION

The exemplary embodiment and/or exemplary method of the present invention is based on the finding that an especially effective and nonetheless safe driver assistance system having driver assistance function LKS may be implemented in that the maximum steering torque provided for driver assistance function LKS is not predefined as a constant, but rather is flexibly implemented and is advantageously adaptively determined via a confidence level. This confidence level advantageously takes the reliability of the lane information ascertained by ambient environmental sensors of the driver assistance system into consideration. Video sensors, advantageously on a CCD or CMOS basis, are advantageously provided as ambient environmental sensors for the driver assistance system. The lower the confidence level, the lower the maximum provided steering torque.

This means, for example, that tight lane guiding using a high maximum steering torque is only available in the event of a high reliability of the lane information, i.e., for example, with well visible lane markings in combination with good visibility conditions. If the visibility is reduced, the maximum steering torque is reduced successively, so that close guiding is no longer available, but rather only a certain torque support of the driver. Threshold values may advantageously be provided. For example, starting at a first threshold value S1, a steering torque M is no longer applied. This means that driver assistance function LKS of the driver assistance system is no longer available, but only driver assistance function LDW. Starting at a second lower threshold value S2, which lies below the first threshold value, driver assistance function LDW is also turned off, since the confidence level is now also too low for this driver assistance function.

This is explained in the following with reference to FIG. 1. FIG. 1 shows a diagram, on whose x axis confidence level V is illustrated in percent. The two curves shown in the diagram represent the availability of driver assistance functions LKS and LDW of the driver assistance system. Above a first lower threshold value S1 of confidence level V, both driver assistance functions LKS and LDW are available without restriction. Upon reaching first threshold value S1, driver assistance function LKS is turned off and only driver assistance function LDW is still available. In the exemplary embodiment illustrated in FIG. 1, the shutdown or deactivation of driver assistance functions LKS and LDW occurs abruptly. This may advantageously be connected to a visual and/or acoustic signal output directed to the driver. In particular if a navigation system is present, a corresponding statement in clear text is also conceivable. Particularly comfortable support of the driver is, however, ensured by a driver assistance system which provides a driver assistance function LKS adapted even better to confidence level V.

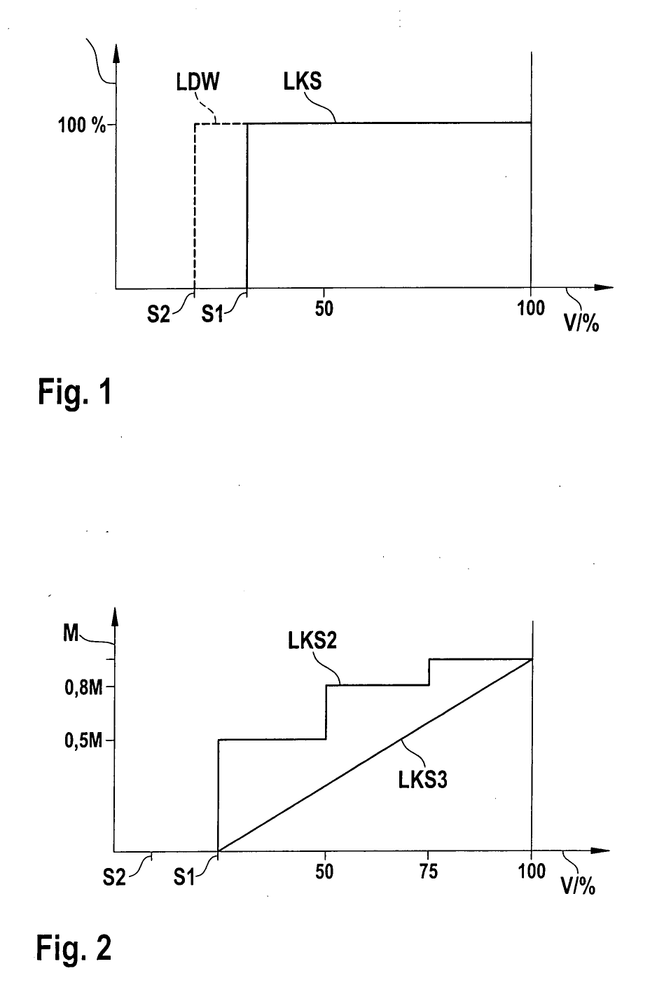

This is explained on the basis of the graph illustrated in FIG. 2. Confidence level V is again shown in percent on the x axis of FIG. 2. Steering torque M is illustrated on the y axis. According to a second embodiment variation LKS2 of driver assistance function LKS, the steering torque provided by driver assistance system LKS2 is reduced stepwise with decreasing confidence level V. At confidence level V=100%, for example, maximum steering torque M may be provided. Maximum value M may, furthermore, also still be available at decreased confidence level V and only be reduced to a lower value 0.8 M at a confidence level of 75%, for example. This lower value of steering torque M may be available upon a further decrease of confidence level V, until the confidence level has assumed the value 50%. A further reduction to the value 0.5 M then occurs. This value remains constant until confidence level V falls below the value 25%, for example. At this limiting value, driver assistance function LKS is turned off. The above limiting values are only cited here as examples and may be adapted in practice to the particular vehicle type in accordance with the purpose. In a further advantageous embodiment variation of the present invention, the steering torque provided in the event of active driver assistance function LKS is a continuous function of confidence level V.

This dependence may be implemented, as shown in FIG. 2, by a linear function LKS3, for example. In this embodiment variation as well, maximum steering torque M is again provided at confidence level V=100%. With decreasing confidence level V, steering torque M also decreases and reaches the value zero at a confidence level of 25%, for example. If confidence level V decreases in a curve due to poorer visibility conditions, for example, so that reduced steering torque M is no longer sufficient for lateral steering of the vehicle, the driver is advantageously prompted by a warning signal to assume or support lateral steering (known as a “takeover request”).

Confidence level V considers individual components or parameters which are linked multiplicatively with one another, for example, to provide confidence level V. If the influencing variables reducing confidence level V no longer apply, confidence level V may again be raised to a higher value, up to the maximum value. The grayscale gradient of the lane markings may particularly advantageously be taken into consideration. A higher value of confidence level V results in the case of high-contrast lane markings with good visibility. A further important factor when ascertaining confidence level V is the reciprocal value of the sum of the error squares of the lane support points of the lane trajectory.

Furthermore, the consistency of the lane information in sequential frames may be taken into consideration during detection of lane markings using video sensors. Information of a navigation system may also be used particularly advantageously when ascertaining confidence level V. If the vehicle is equipped with a navigation system, a factor influencing the confidence level may advantageously be derived based on a plausibility check. For example, if the navigation system indicates a two-lane highway, a high confidence level may be assumed if the ambient environmental sensors of the driver assistance system also detect three lane markings. When driving on a highway, a higher confidence level V may be generally applied than when driving on other roads. On roads in heavily populated traffic areas, in particular inner-city roads, confidence level V is expediently set to zero. Output signals of further sensors of the vehicle are advantageously also taken into consideration when ascertaining the confidence level.

If a light sensor is provided, which also controls the turning on and off of the vehicle lighting automatically as a function of the day brightness, for example, its output signal may also advantageously be used for ascertaining confidence level V. If the video sensor of the vehicle provided for lane detection has no or only limited night vision capability, a lower confidence level is expediently predefined if a low brightness level is established by the light sensor than in the event of good visibility under daylight conditions. Furthermore, the output signal of a rain sensor, which is provided for controlling the windshield wipers of the vehicle, for example, may advantageously be used for determining confidence level V.

In the event of rain, it may be assumed that the visibility conditions for the video sensor of the driver assistance system are also worse than if there is no precipitation. Furthermore, lower road adherence of the vehicle is to be expected, so that in particular when negotiating curves and when using a high steering torque, breakaway of the vehicle has to be expected. If there is precipitation, such as rain and the like, confidence level V is therefore set lower than if it is dry. Furthermore, the output signal of a mist sensor may advantageously be taken into consideration when establishing confidence level V. Specifically, if the windshield is misted over, the risk exists that the visibility range of the video sensor of the driver assistance system is also restricted. A lower confidence level V is then expediently set than in the event of good visibility through a windshield which is not misted over. Alternatively, a possibly interfering mist situation may also be determined from indirect measured variables, such as internal temperature, external temperature, moisture content, etc. The external temperature may also advantageously be monitored with the aid of a temperature sensor.

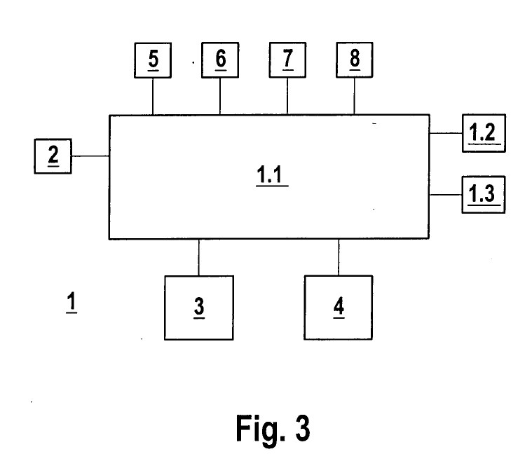

In the event of temperatures around or below the freezing point and an imminent danger of slipping on ice, which forbid the use of a high steering torque, the confidence level is also expediently reduced to the value zero. In combination with an AFIL lane departure warning system, the confidence level may expediently be reset to the value zero immediately if the lane departure warning system has detected unintentional driving over a lane marking. In order to exclude any risk in the event of an unclear driving situation, such as when driving through a construction site, the confidence level is expediently also reduced to zero. These embodiment variations of the present invention may be implemented using a driver assistance system 1, which is illustrated schematically in FIG. 3 as a block diagram.

Driver assistance system 1 includes a control unit 1.1. A navigation system 2 is connected to control unit 1.1. Furthermore, multiple sensors are connected to the inputs of control unit 1.1. A video sensor 1.2 and possibly a radar sensor 1.3, as well as further sensors 5, 6, 7, 8 are illustrated as examples, not as an exhaustive list, in FIG. 3. The video sensor is advantageously situated as a forward-looking sensor in the front area of the vehicle (not shown) and is also used in particular to detect roadway markings. Sensor 1.3 is a further ambient environmental sensor based on radar, which supplies an ACC system with measured values, for example. A light sensor is identified by reference numeral 5. A rain sensor is identified by reference numeral 6. A mist sensor is identified by reference numeral 7. A temperature sensor is identified by reference numeral 8. Control unit 1.1 is also connected to steering system 3 of the vehicle and to brake system 4 of the vehicle.

Control unit 1.1 of driver assistance system 1 analyzes the signals of partial systems identified by reference numerals 1.2, 1.3, 2, 5, 6, 7, 8 and ascertains a confidence level V in accordance with the criteria already described above. Steering system 3 and/or brake system 4 of the vehicle is/are controlled as a function of confidence level V to provide an appropriate steering torque or an asymmetrical braking torque for the lateral steering of the vehicle within the scope of driver assistance function LKS. The particular functional state of driver assistance system 1 is advantageously communicated to the driver via an HMI (human machine interface), which is as simple as possible, and easily recognizable signals. For example, a chain of LEDs (light emitting diodes) which visually signal the state of the driver assistance system by their particular activation may be provided as a suitable interface. Confidence level V or a variable derived therefrom is used as an input variable.

For example, the right outside LED in the chain of LEDs is activated when driver assistance function LKS having the maximum steering torque is available. The left outside LED in the chain is activated when neither of driver assistance functions LKS, LDW are available. Intermediate stages such as LKS having moderate or low steering or only the use of LDW are indicated by activating LEDs lying within the chain. Of course, it is also possible to further increase the clarity of the signal output by using different colored LEDs. A combination with an acoustic warning signal at important changeover points (LKS>LDW; LDW>no support) is advantageous.

When using the exemplary embodiment and/or exemplary method of the present invention, driver assistance function LKS remains purely a comfort function, which is only available to its full extent in the case of good driving conditions. The worse the environmental and traffic conditions are, the greater is the responsibility of the driver. The risk of incorrect interventions if LKS is used with the maximum steering torque is significantly reduced. In an alternative embodiment variation, the steering torque is not applied via the steering system of the vehicle, but rather with the aid of the brake system, by braking individual wheels in a targeted way. A combination of steering and braking interventions is also conceivable.

What is claimed is:

1. A driver assistance system, comprising:
an arrangement for providing at least driver assistance functions, including at least one of LDW (lane departure warning) and LKS (lane keeping support), wherein activation and deactivation of the driver assistance functions are a function of a confidence level.

2. The driver assistance system of claim 1, wherein a size of a torque provided for automatic lateral steering of the vehicle is a function of the confidence level.

3. The driver assistance system of claim 1, wherein the confidence level is a function of a quality of a lane detection.

4. The driver assistance system of claim 1, wherein a grayscale gradient of roadway markings or lane markings, is taken into consideration when ascertaining the confidence level.

5. The driver assistance system of claim 1, wherein the confidence level is a function of a reciprocal of a sum of error squares of lane support points of a lane trajectory.

6. The driver assistance system of claim 1, wherein the confidence level is a function of consistency of lane information over sequentially recorded frames of an image detection system.

7. The driver assistance system of claim 1, wherein the confidence level is a function of a plausibility comparison between signals of an ambient environmental sensor and signals of a navigation system.

8. The driver assistance system of claim 1, wherein the confidence level is a function of an ambient brightness.

9. The driver assistance system of claim 1, wherein the confidence level is a function of a signal of a rain sensor.

10. The driver assistance system of claim 1, wherein the confidence level is a function of a signal of a mist sensor.

11. The driver assistance system of claim 1, wherein the confidence level is a function of a signal of a temperature sensor.

12. The driver assistance system of claim 1, wherein an interface is provided for representing states of the driver assistance functions.

13. The driver assistance system of claim 1, wherein the interface includes at least one of light emitting diodes and an acoustic warning unit.

14. A method for controlling a driver assistance system, which includes a driver assistance function, including at least one of LDW (lane departure warning) and LKS (lane keeping support), the method comprising:
determining a confidence level and at least one of an activation and a deactivation of the driver assistance functions as a function of a confidence level.

15. The method of claim 14, wherein threshold values are provided for the confidence level, and if the confidence level falls below a threshold value, a characteristic quantity of the driver assistance function is at least reduced, or a driver assistance function is deactivated.

16. The method of claim 14, wherein the confidence level is reduced stepwise.

17. The method of claim 14, wherein the confidence level is reduced continuously.
